(19) United States
(12) Patent Application Publication
(10) Pub. No.: US 2005/0066149 A1
(43) Pub. Date: Mar. 24, 2005

(54) Method and system for multithreaded processing using errands

(75) Inventor: Udayan Rajendra Kanade, Maharashtra (IN)

Correspondence Address: William L. Botjer, PO Box 478, Center Moriches, NY, 11934, US

(73) Assignee: CODITO TECHNOLOGIES PRIVATE LIMITED, MAHARASHTRA (IN)

(21) Appl. No.: 10/667,549

(22) Filed: Sep. 22, 2003

(51) Int. Cl. G06F 15/00

(52) U.S. Cl. 712/1

(57) ABSTRACT

The disclosed invention provides a system, method and computer program product for processing multithreaded application programs. The application threads are written using itineraries, which are lists of errands. The errands are small tasks that collectively constitute the entire thread's functionality. An itinerary is executed via an itinerary running service provided by the operating system, using the kernel stack as its execution stack. When an itinerary is encountered in a thread, the thread is preempted and the itinerary execution is taken over by the itinerary running service in itinerary mode. The thread remains preempted in normal mode until the complete itinerary has been executed. Within the itinerary mode, the errands are executed in the sequence specified by the itinerary, until an errand blocks. The itinerary is resumed from the same errand that previously blocked the thread.

### BACKGROUND

The disclosed invention relates generally to multithreaded application processing for computing applications. More specifically, it relates to a system and method for reducing thread switching overheads and minimizing the memory usage during multithreaded application processing in single processor or multiple processor configurations.

With the development of complex computing applications, modern application programming has become quite intricate. Application programs created these days pose a requirement for extensive processing resources. However, available processing resources may not satisfy this requirement. Hence, it is essential that the available processing resources be optimized. At the same time, the application program needs to be run as efficiently as possible, while still maintaining the process complexities. Use of multithreaded programming has proved to be beneficial in optimizing the available processing resources as well as efficiently running the application program.

In multithreaded programming, an application program is written as a set of parallel activities or threads. A thread is an instance of a sequence of code that is executed as a unit. The partitioning of an application program into multiple threads results in easily manageable and faster program execution. This partitioning in multithreaded programming involves usage of imperative programming. Imperative programming describes computation in terms of a program state and statements that change that program state. Imperative programs are a sequence of commands for the computer to perform. The hardware implementation of most computing systems is imperative in nature. Nearly all computer hardware is designed to execute machine code, which is always written in imperative style. Therefore, complex multithreaded programs are preferably written using an imperative language. Most of the high level languages, like C, support imperative programming.

In multithreaded programming, a compiler compiles the threads associated with an application program before execution of the program. The compiler converts the user-written code to assembly language instructions that can be interpreted by processor hardware. The compiler creates a virtual thread of execution corresponding to a user-written thread. The virtual thread constitutes the user-written thread and an associated data structure for running the thread. This virtual thread is subsequently mapped to the processor during execution. There may be a plurality of virtual threads corresponding to each user-written thread or vice versa, depending upon the application program requirement.

Each thread requires certain resources like processor time, memory resources, and input/output (I/O) services in order to accomplish its objective. An operating system allocates these resources to various threads. The operating system provides a scheduling service that schedules the thread for running on the processor. In case of a multiprocessor configuration, the scheduling service schedules the thread to run on an appropriate processor. All threads are stored in main memory, which can be directly accessed by the processor. The main memory is a repository of quickly accessible data shared by the processor and the I/O. It is an array of words or bytes, each having its own address. Some data processing systems have a larger but slower memory while others may have a smaller but faster memory. Most of the currently used memory architectures use a heterogeneous memory model, including small, fast memory as well as large, slow memory.

The processor interacts with the main memory through a sequence of instructions that load or store data at specific memory addresses. The speed at which these instructions are executed is termed as the memory speed. Memory speed is a measure of the assistance provided by the memory of a data processing system to multiple ongoing computations within the processors. The time duration taken for memory access depends upon the memory speed available. During this period, the data required to complete the instruction being executed is not available to the processor. Hence, the processor executing the instructions waits for this process. To accommodate such a speed differential, a memory buffer called a cache is sometimes used in conjunction with the main memory. A cache provides an additional fast memory between the processor and the main memory. A small number of high-speed memory locations in the form of registers are also located within the processor. Relevant data for the execution of a program is stored in the form of stacks and other data structures within the fast memory. Each processor generally has a kernel stack associated with it. This stack is used by the operating system for specific functions such as running interrupts, or running various operating system services.

Each process or virtual thread of execution generally has a program counter, other registers, and a process stack associated with it. Program counters are registers that contain information regarding the current execution status of the process. These registers specify the address of the next instruction to be executed along with the associated resources. The process stack is an execution stack that contains context information related to the process. Context information includes local data and information pertaining to the activation records corresponding to each function call. Local data consists of process information that includes return addresses, local variables, and subroutine parameters. The local variables are defined during the course of process execution. Besides, certain temporary variables may be created for computation and optimization of complex expressions. Common sub-expressions may be eliminated from such expressions and their value may be assigned to the temporary variables. The context information defines the current state of execution of the thread. While swapping out of a processor, the active context information pertaining to the thread is stored on the thread's execution stack. In certain systems, a separate memory area is assigned for storing the context of a thread while swapping.

The scheduling service of the operating system manages the execution of threads on the processing system. The scheduling service ensures that all processes gain access to processing resources in a manner that optimizes the processing time. In order to do this the operating system has to, either periodically or when requested, swap the thread running on a particular processor with another thread. This is called thread switching. The operating system maintains a ready queue that sequentially holds threads, which are ready for execution and are waiting for processor resources. A temporarily stalled thread is scheduled back on a processor when it reaches the head of the ready queue.

A thread may voluntarily preempt by yielding processor resources and stalling temporarily. This may happen if a desired resource is unavailable or the thread needs to wait for a data signal. Typical preemptive services that may cause a thread to preempt include synchronization mechanisms like semaphores, mutexes, and the like. These services are used for inter-thread communication and coordinating activities in which multiple processes compete for the same resources. For instance, a semaphore, corresponding to a resource, is a value at a designated place in the operating system storage. Each thread can check and then change this value. Depending on the value found, the thread could use the resource or wait until the value becomes conducive to using the resource. Similarly, mutexes are program objects created so that multiple program threads can take turns sharing the same resource. Typically, when a program is started, it creates a mutex for a given resource at the beginning by requesting it from the system. The system returns a unique name or identification for it. Thereon, any thread needing the resource must use the mutex to lock the resource from other threads while using the resource. Another class of preemptive services is related to input-output and file access. Alternatively, a thread may preempt while waiting for a timer signal or a DMA transfer to complete. A thread may also be waiting for receiving access to a special-purpose processor or simply waiting for an interrupt.

Thread switching entails saving the context information of the current thread and loading the context information related to the new thread. This is necessary so that execution of the preempted thread may be resumed later at the point of preemption. The switching time is pure overhead because the system doesn't do any useful work during switching. The speed of switching depends on the processor used. It also depends on the memory speed, the number of registers to be copied and the existence of special instructions. For example, lower thread switching overheads will be involved if a system uses a single instruction to load or store all the registers. The thread switching time typically ranges from 1 to 1000 microseconds.

Thread switching further involves changing the stack pointer to point to the current register set or execution stack associated with the new thread. The stack pointer is a reference means used by the operating system. The stack pointer refers to the address of the register set of the processor on which a given thread needs to be executed next. A separate execution stack needs to be maintained for each thread in the memory. In order to make thread execution and switching faster, the execution stacks may be put in fast local memory. The number of execution stacks that can fit into the fast memory limits the number of threads that can be used.

In case of systems using a cache in conjunction with the main memory, if the number of threads is more than the number of processors, the performance of the system may be impaired during thread switching. Cache congestion may occur due to frequent copying of data to and from the memory resulting from accesses to different stacks.

The current state of art provides certain systems that attempt to reduce thread-switching overheads. One such system is described in U.S. Pat. No. 6,223,208, assigned to International Business Machines Corporation, NY, USA, titled “Moving Data In And Out Of Processor Units Using Idle Register/Storage Functional Units”. This patent provides a system that is primarily a hardware-based methodology. This methodology attempts to reduce context switch overheads by hiding the memory latencies involved with other processing. However, it does not actually reduce the amount of active context information that a thread needs to store. Besides, it entails addition of new circuitry to the processors. It applies only to multithreaded processors and not general-purpose single or multiprocessor systems.

U.S. Pat. No. 5,872,963, assigned to Silicon Graphics, Inc. CA, USA, titled “Resumption Of Preempted Non-Privileged Threads With No Kernel Intervention”, provides a system and method for context switching between a first and a second execution entity without having to switch context into protected kernel mode. The system provides a special jump-and-load instruction on the processor for achieving the purpose. However, it only removes the overhead of jumping into kernel mode while switching threads. It does not address the basic problem of reducing overheads related to the actual context information load. Besides, the method is only effective and useful in case of voluntary thread yield in a preemptive system.

Moreover, the above systems do not attempt to reduce memory congestion that happen due to repeated calls to execution stacks of different threads. The number of execution stacks that can fit into the fast memory also limits the number of threads that can be used.

In light of the foregoing discussion, there is need for a system and method that reduces the thread switching overheads by reducing the amount of active context associated with a thread. The system should also minimize the local memory usage and congestion in order to free the local memory for other important purposes. The system should be applicable to single as well as multiple processor configurations. A need also exists for a system, which is effective and useful in a preemptive as well as non-preemptive operating system environment.

### SUMMARY

The present invention is directed to a system and method for minimizing thread switching overheads and reducing memory usage during multithreaded application processing.

An object of the invention is to provide a method and system for efficient multithreaded processing in single as well as multiple processor configurations.

Another object of the invention is to provide a new methodology for writing the threads using errands, allowing minimal switching overheads.

A further object of the invention is to ensure that the amount of active context associated with a thread is minimal.

Yet another object of the invention is to provide a method and system that does not require storage of reference information of a thread while the thread is being swapped.

Still another object of the invention is to minimize cache congestion caused due to thread switching.

Yet another object of the invention is to minimize the number of execution stacks for various threads that need to be maintained within the local memory.

In order to achieve the foregoing objectives, and in accordance with the purpose of the disclosed invention as broadly described herein, the disclosed invention provides a new thread programming methodology and a method and system for executing the same. The threads are written in the form of itineraries, which are lists of errands. The errands are small tasks that need to be performed during thread execution. The threads may be fully itinerarized, in which case the entire thread's functionality may be programmed in the form of errands. A compiler compiles the application code, which is subsequently executed on at least one processor by the operating system.

The itinerary corresponding to a thread is executed via an itinerary running service provided by the operating system. When an itinerary is encountered in a thread, the thread is preempted and the itinerary execution is taken over by the itinerary running service in itinerary mode. The thread remains preempted in normal mode until the complete itinerary has been executed. Within the itinerary mode, the errands are executed in the sequence specified by the itinerary, until an errand blocks. The itinerary is resumed from the same errand that previously blocked the thread. This scheme drastically reduces the requirement for thread switching with saving and loading of reference information. The itinerary corresponding to a thread is executed using the kernel stack as its execution stack. This minimizes the memory usage and cache congestion involved in thread switching.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a schematic diagram representing the multithreaded processing environment in which the disclosed invention operates;

FIG. 2A schematically illustrates the standard thread running service of the operating system;

FIG. 2B schematically illustrates the itinerary running service of the operating system;

FIG. 3 is a flowchart that illustrates the basic process steps occurring during the execution of a thread of the application program;

FIG. 4 is a flowchart that illustrates the process steps that occur when an itinerary is passed on to the operating system for execution; and

FIG. 5 is a flowchart that depicts the process steps occurring during execution of a preemptive errand in conjunction with an exemplary pseudo-code.

### DESCRIPTION OF PREFERRED EMBODIMENTS

The disclosed invention provides a system and method for writing and executing multiple threads in single as well as multiple processor configurations. In a multithreaded processing environment, switching overheads involved in thread switching limit the number of threads that an application can be split into. In addition, the number of heavy execution stacks that can fit in fast memory also limit the number of threads that can be simultaneously processed.

The disclosed invention uses a new way of programming the threads. The threads are programmed uses a series of multiple small tasks (called errands). The desired sequence of errands is given to the operating system for execution in the form of an itinerary. The programming methodology of the disclosed invention results in minimizing switching overheads as well as reducing the memory usage required for processing the threads.

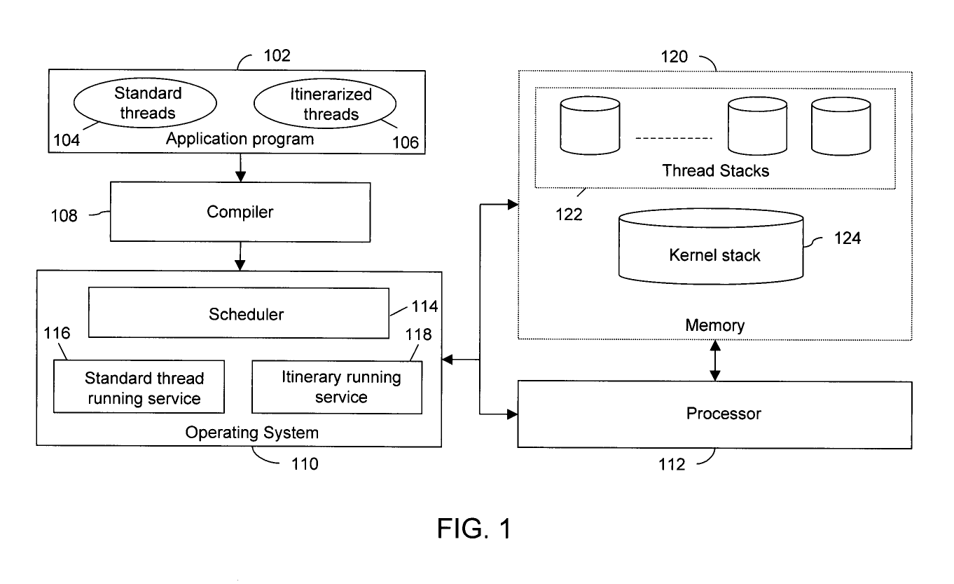

FIG. 1 is a schematic diagram representing the multithreaded processing environment in which the disclosed invention operates. The multithreaded processing environment comprises an application program 102, a compiler 108, an operating system 110, at least one processor 112 and memory 120. Application program 102 is written as a series of functions and other program constructs using standard threads 104 and itinerarized threads 106. Standard threads 104 are conventional threads, which are written, compiled and executed according to standard thread methodology. The standard thread methodology is well known in the art and it should be apparent to anyone skilled in the art. Itinerarized threads 106 are specially written and executed in accordance with the method of the disclosed invention.

Compiler 108 compiles application program 102. The compiled application code is executed by operating system 110 on a computer having one or more processors 112. This involves periodic loading of certain threads on the processors while blocking execution of other threads. This is done via a scheduler 114, which schedules various standard and itinerarized threads on processors. Scheduler 114 maintains a ready queue that holds standard and itinerarized threads in a ready state. A ready state of the threads implies that these threads are ready for processing and are waiting for allocation of a free processor to them.

Operating system 110 also provides a standard thread running service 116 and an itinerary running service 118. Standard threads 104 are executed by processor 112 according to the standard thread methodology using standard thread running service 116. Activation records of the threads as well as their context are stored on thread stacks 122 stored in memory 120, when these threads swap out in normal mode. In the normal mode, the threads are executed in accordance with the standard thread execution methodology. Thread stacks 122 keep track of various function calls and returns, in addition to storing the required local variables. There is one independent stack for each thread.

Itinerarized threads 106 may be executed partially in the normal mode wherein they behave like standard threads, and partially in itinerary mode wherein they are executed using an itinerary running service 118. During application execution, a thread is said to be running in itinerary mode when an itinerary corresponding to the thread is being executed. Otherwise it is said to be running in the normal mode. The kernel stack 124 associated with processor 112 is used as the execution stack in turns by all threads running in itinerary mode on that processor. In a multiprocessor environment there is one such kernel stack associated with each processor. This is the internal execution stack for the operating system corresponding to the processor.

The thread programming methodology of the disclosed invention involves programming threads using a series of errands. Errands are specific tasks that the operating system performs on behalf of the thread. An application program may use standard errands, which are directly recognizable by the operating system. Besides, it may use application-specific errands written by the application programmer. The errands are given over to the operating system in the form of a list called an itinerary. A thread may be fully itinerarized, in which case the entire thread functionality is programmed in the form of errands. Within the multithreaded application, multiple threads may share an itinerary. The itinerary instructs the operating system about the sequence in which specific errands are to be processed and the data that is required for processing. In an embodiment of the invention, the sequence of errands is stored in the itinerary in the form of function pointers in an errand function list. A general errand data list, referred hereinafter as a data list, stores data that is required for processing the errands on the errand function list. Access to the errand function list and data list is controlled by a function list pointer and a data list pointer respectively. These pointers are stored in the itinerary data structure.

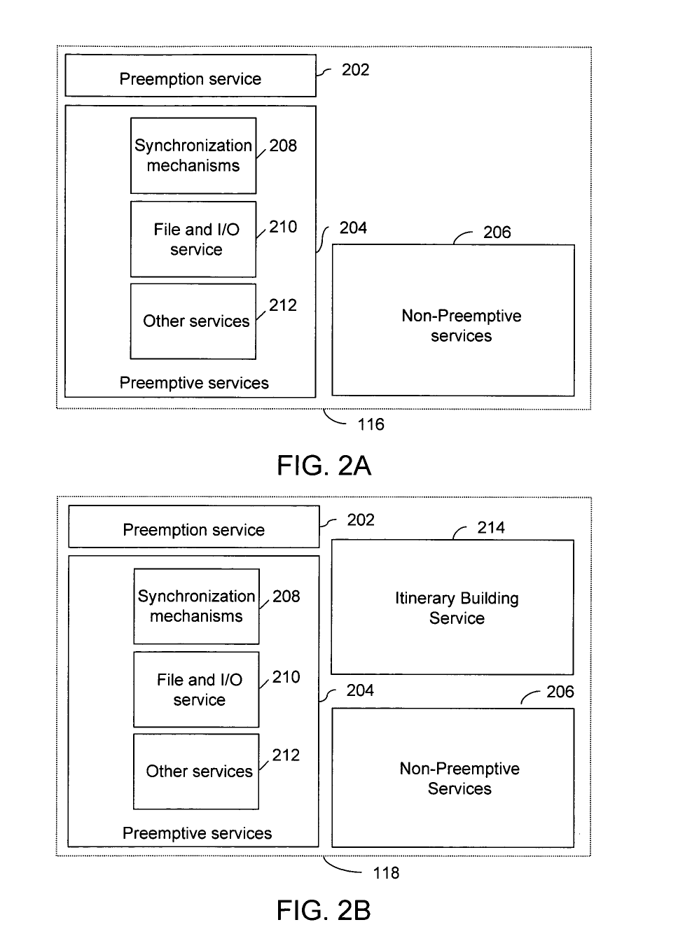

FIG. 2A schematically illustrates the standard thread running service of the operating system. Standard thread running service 116 provides a preemption service 202 that enables thread preemption calls. Various preemptive services 204 and non-preemptive services 206 are also provided to standard threads. Preemptive services 204 include various services like inter-thread communication and synchronization mechanisms 208 using semaphores, mutexes or mailboxes. Preemptive services 204 are enabled through preemption service 202. Using these services, a thread can wait for a signal or data from another thread. While the signal or data does not appear, the thread is swapped out of the processor, so that the processor resource may be utilized by another thread.

Another class of preemptive services is file and input/output (I/O) services 210 wherein access to a resource is governed by a set of criteria. Examples of these criteria include elapsed time for using a resource, priority of task and the like. Other services 212 may also be provided to the threads as required. For instance, a thread can request for preemption while waiting for a timer signal, data transfer or waiting for an interrupt. Non-preemptive services 206 include various operating system services for specific computations and processes that are not preemptive in nature. Examples of such services include semaphore posts, waking up threads, loop execution libraries, standard program constructs, predefined functions etc.

FIG. 2B schematically illustrates the itinerary running service of the operating system. Itinerary running service 118 enables building and execution of threads in itinerary mode. In addition to preemption service 202, standard preemptive services 204 and non-preemptive services 206, it provides an itinerary building service 214. Itinerary building service 214 aids in the setting up of the itinerary. A computing job or an errand is written as a function and the function pointer is put in the itinerary through itinerary building service 214. If the errand requires any special data, such data is also saved in the itinerary data list through itinerary building service 214. In addition, itinerary building service 112 facilitates passing of data from one errand to another by allocating space for variables on the itinerary data list.

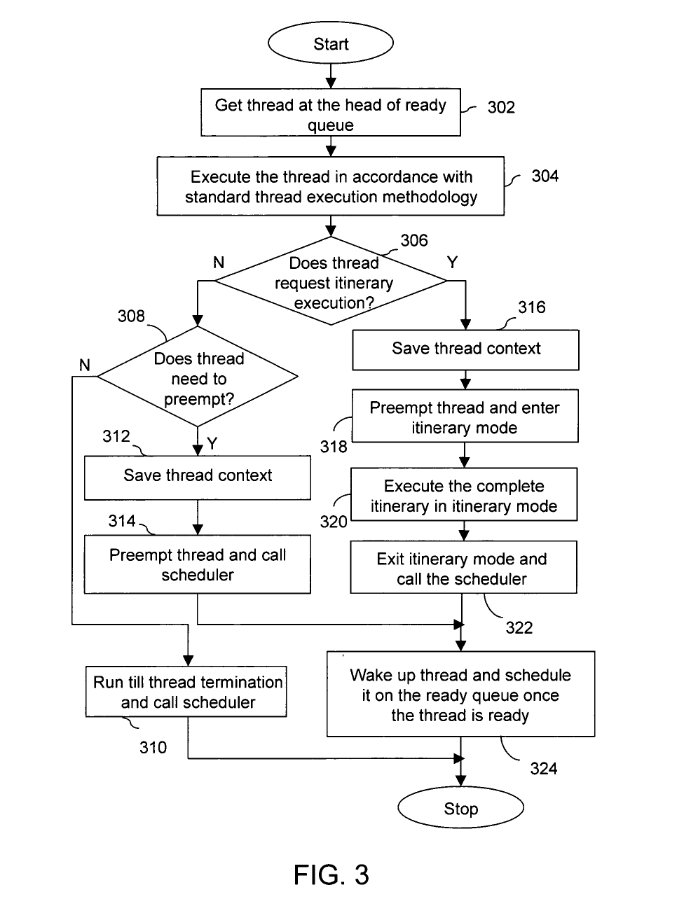

FIG. 3 is a flowchart that illustrates the basic process steps occurring during the execution of a thread of the application program. At step 302 a ready thread is selected from the ready queue by scheduler 114. The selected thread is loaded on one of the free processors 112. The thread is executed at step 304 in accordance with the standard thread execution methodology. This involves loading the thread's context by pointing the processor's stack pointer to the stack pointer value stored in the thread's data structure. The stack thus pointed is the stack associated with the loaded thread, and stores context information required for further processing of the thread. Execution of the standard thread is carried out by standard thread running service 116. The standard thread execution methodology is well known in the art and will be apparent to one skilled in the art.

During the course of execution the thread may request running an itinerary. If the thread does not make such a request at step 306, then it continues execution in normal mode. During the course of execution, at step 308, it is checked whether the thread needs to be preempted. In case the thread needs to be preempted, its context is stored in accordance with step 312. The thread is preempted at step 314 and the scheduler is called to schedule in the next thread on the ready queue. If the thread does not need to be preempted, then it is executed until its termination and the scheduler is called in accordance with step 310.

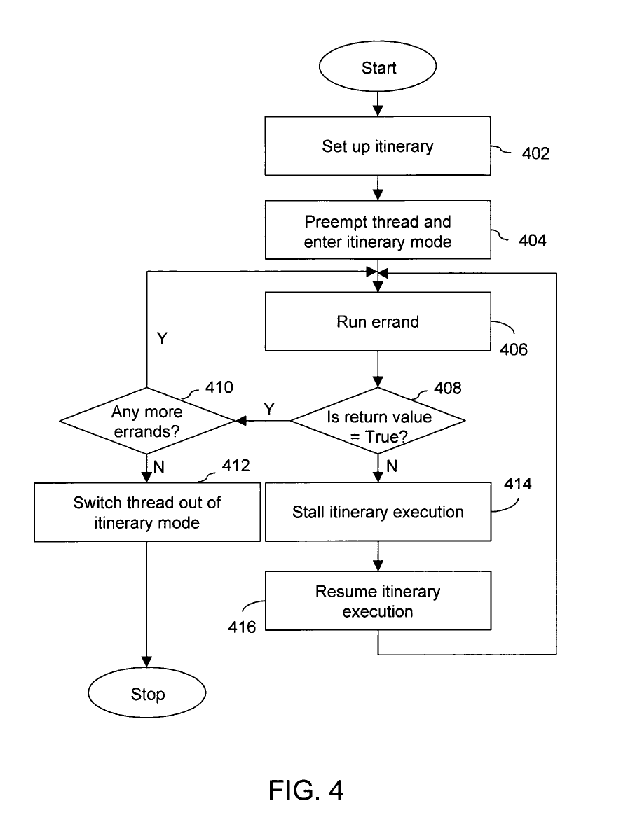

In case the thread requests running an itinerary at step 306, the thread needs to be preempted and switched out of normal mode. The thread's context is stored in accordance with step 316. At step 318 the thread is preempted in the normal mode and enters itinerary mode. In the itinerary mode, the thread is executed through itinerary running service 114 of the operating system. Once the thread enters itinerary mode, it continues to execute the errands on the itinerary until the entire itinerary is executed, in accordance with step 320. This step will be further elaborated upon in conjunction with FIG. 4. At step 322, upon completion of itinerary execution, the thread exits the itinerary mode. It calls the scheduler to schedule the next thread at the head of the ready queue.

Once a preempted thread is ready for execution, it is woken up at step 324. In other words, the preempted thread is brought back on the scheduler's ready queue for subsequent execution. Normal threads need to be frequently preempted and woken up once for each function call that preempts the thread. However, in case of itinerarized threads, once the thread enters itinerary mode, it is preempted once and swapped back in normal mode only when all errands on the itinerary have been executed. Many of the errands on the itinerary may be preemptive in nature. However, the thread needs only one physical swapping out of the normal mode in this case. This helps in reducing multiple context switches to a much lower number.

In the preferred embodiment of the invention, scheduler 114 of the operating system is itinerary-enabled. In other words, it treats threads running in itinerary mode in a manner similar to standard threads running in normal mode, as far as scheduling the threads is concerned. There are many ways for scheduling the itinerary mode threads with respect to standard threads. One way is to make the same ready queue for the itinerary mode threads as well as the standard threads. In this case, the scheduler does not differentiate between the threads with respect to scheduling.

Another way to schedule itinerary-mode threads with respect to standard threads is to set different priorities for the itinerary mode and the normal mode. These priorities could be implemented preemptively or non-preemptively.

Yet another way to schedule different threads is to allocate different processors for running the itinerary-mode threads and the standard threads. In this case, if a particular itinerary is known to have only standard errands in it, it could be written to run on a specially programmed special purpose processor.

FIG. 4 is a flowchart that illustrates the process steps that occur when an itinerary is passed on to the operating system for execution. At step 402, the itinerary is set up by the operating system. Setting up of the itinerary involves creating the errand function list and data list corresponding to the itinerary. In an embodiment of the invention, the setting up is done using itinerary building service 214. After setting up the itinerary, the thread running the itinerary is preempted at step 404. At this stage, the thread is blocked and enters the itinerary mode of execution. This involves saving the context of the thread on its execution stack and swapping it out. This is done in accordance with the standard thread execution methodology where the thread uses stack execution model.

At step 406 the errands in the itinerary are executed by itinerary running service 118 in the sequence specified by the itinerary. For itinerary running service 118, an errand is just a pointer to a function that is to be called. The itinerary maintains a list of function pointers in the errand function list, as explained earlier. Each function returns a value of true or false upon execution. A return value of true stands for completion of errand. A return value of false implies that the errand failed to complete, and the itinerary should not execute any further.

In an embodiment of the disclosed invention, the functions need not return a true or false return value for indicating successful execution or preemption of an errand. Inline function calls may be used instead of returning a specific value. These inline function calls facilitate the execution control to directly move to the next errand in case of successful errand execution or call the scheduler loop for executing the next thread when an errand blocks.

In another embodiment of the disclosed invention, the errand functions may return specific computation results through return values. These results may be stored within the errand data list. This functionality is useful when the functions perform certain critical computations and the results of those computations need to be stored for future reference.

At step 408 it is checked whether an errand returned a true value or a false value. In case the errand returns true, it signifies that the errand has been executed successfully. Thus, the next thread in the itinerary is scheduled for execution. If at step 410 there are no more errands, the thread switches out of the itinerary mode at step 412. This thread is thereafter executed as a standard thread.

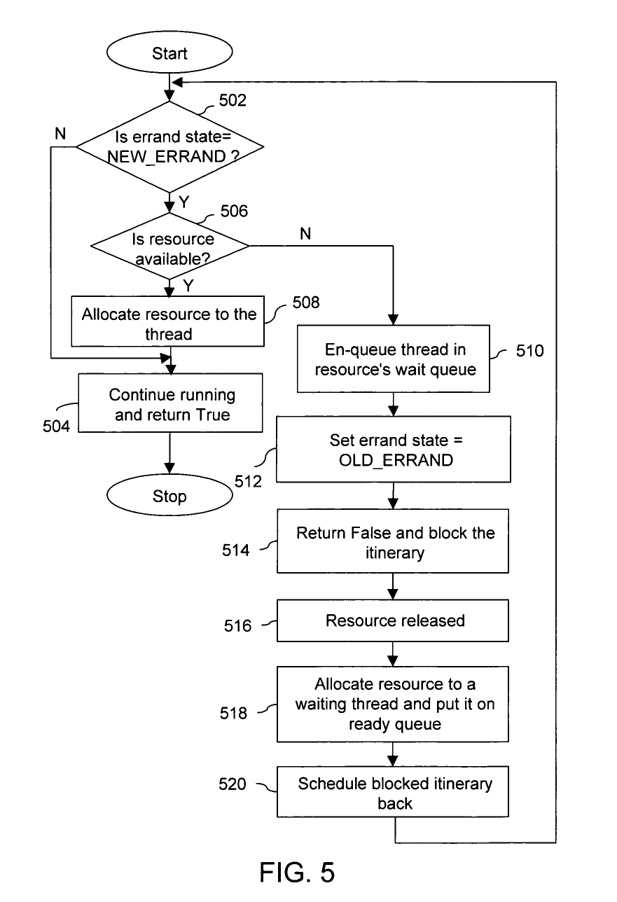

If at step 408, an errand returns a false value, it signifies that the errand failed to complete. The itinerary is thereby stalled at step 414 and is not woken up until the thread is ready again. When the thread is ready for execution, it is scheduled back on the ready queue. Subsequently, the scheduler schedules back the thread. Being in the itinerary mode, the thread execution is taken over by itinerary running service 118. The itinerary execution is resumed at step 416. Execution resumes at the errand that returned a false value, i.e. the errand that blocked the thread earlier. This step will be elaborated upon in conjunction with FIG. 5. When the itinerary execution is completed, the thread switches out of the itinerary mode, as explained earlier.

In an alternative embodiment of the disclosed invention, a thread running in normal mode is not preempted when the thread requests for running the itinerary. The errands are executed sequentially, and the thread is preempted only when an errand blocks. In case the complete itinerary is executed without any errand blocking it, the overheads involved in saving the thread context and switching it out are prevented.

Alternatively, the thread is executed in the itinerary mode on the kernel stack without making a physical context switch from the thread's execution stack. The kernel stack is present on fast local memory, thus speeding up the itinerary execution. In case an errand blocks the itinerary, the thread is preempted by making a physical context switch.

This methodology of thread execution reduces the number of physical thread switches and the resultant switching overheads. A conventional thread may require frequently preempting and swapping out of the processor. This entails saving the context of the thread on its execution stack and loading the same each time the thread is swapped back in. On the other hand, a thread running an itinerary is blocked until all the errands on the itinerary have been executed. Thus, when more than one errand, with at least a few which are preemptive in nature, are put on a single itinerary, the number of physical thread switches that occur can be drastically reduced.

The errands do not need separate execution stacks for their execution. Instead, they use the operating system's internal stack i.e. kernel stack as their execution stack. The operating system needs just one such stack per processor. Hence the number of stacks used is small and independent of the number of threads that the application is split into. The overall memory requirement is reduced. This functionality can be used to free up local memory for other important purposes. In case of cached systems, this results in minimization of cache congestion that would otherwise happen due to repeated thread switching and calls to different stacks.

The following simple example illustrates the programming methodology of the disclosed invention. Suppose a function within a standard thread is written as follows.

```
func ( )
{
    // perform computation
    semaphore_wait (a);
    semaphore_wait (b);
    semaphore_wait (c);
    // perform computation
}
```

The same functionality may be achieved through the following exemplary pseudo-code.

```
func ( )
{
    // perform computation
    run_itinerary (itinerary_multiple_wait_a_b_c);
    // perform computation
}
```

The itinerary_multiple_wait_a_b_c is set up earlier during the running of the application using the following function calls.

```
begin_itinerary (itinerary_multiple_wait_a_b_c);
    errand_semaphore_wait (itinerary_multiple_wait_a_b_c, a);
    errand_semaphore_wait (itinerary_multiple_wait_a_b_c, b);
    errand_semaphore_wait (itinerary_multiple_wait_a_b_c, c);
end_itinerary (itinerary_multiple_wait_a_b_c);
```

The begin_itinerary and end_itinerary calls together set up the itinerary while run_itinerary preempts the actual thread. The itinerary_multiple_wait_a_b_c itinerary is then executed completely before scheduling the thread back in.

The following example illustrates the manner in which a thread may be made to run completely within an itinerary. A standard thread which acts a consumer for some thread, and as a producer for some other thread can be written as under.

```
thread_main ( )
{
    for (;;)
    {
        semaphore_wait (sem1);
        semaphore_wait (sem2);
        // do specific computation
        semaphore_post (sem3);
        semaphore_post (sem4);
    }
}
```

This thread would need to preempt itself frequently corresponding to each preemptive call. The same functionality can be achieved through an itinerary in the following manner.

```
thread_main ( )
{
    begin_itinerary (itinerary, function_list, data_list);
    loophandle = errand_forever_begin (itinerary);
    errand_semaphore_wait (itinerary, sem1);
    errand_semaphore_wait (itinerary, sem2);
    itk_add_errand (computation);
    errand_semaphore_post (itinerary, sem3);
    errand_semaphore_post (itinerary, sem4);
    errand_forever_end (itinerary, loophandle);
    end_itnerary (itinerary)
    run_itinerary (itinerary)
}
computation ( )
{
    // specific computation
}
```

In the above example, the itinerary is setup between the begin_itinerary and the end_itinerary calls. After the itinerary is setup, run_itinerary preempts the actual thread. This thread never runs directly again. However, the thread continues running in the itinerary mode. The itinerary runs repeatedly without terminating. The continuous running of the itinerary is due to the fact that the itinerary is written using a loop errand providing an infinite loop for the itinerary. In the above-mentioned example, the errand_forever_begin and errand_forever_end calls provide the non-terminating characteristic to the itinerary.

The semaphore errands, as used in the example above, are the standard errands provided by the operating system as preemptive services 204. Other examples of standard errands include calling of various resource allocation libraries, forever loops, for loops and if statements.

The errand computation is a special errand written by a programmer and performs application specific computation. It is written as a normal function, the pointer to which is stored on the itinerary function-list using a special function provided by itinerary building service 112. In the above example, this function is represented as itk_add_errand. A similar function is used by the standard errands such as errand_semaphore_wait. The semaphore wait call can equivalently be written as follows.

itk_add_errand (itinerary, semaphore_wait_as_errand);
itk_put_data (itinerary, sem1);

The data inputs required by the errand can be provided on the itinerary data list using the function call itk_put_data. The argument semi in the called function itk_put_data represents the specific computational job that is to be performed in this errand.

Special-purpose errands may be written to modify the control flow of the itinerary. There can be loops and conditional execution of errands. An errand that modifies control flow does so by changing the pointer to the current errand, and pointer to the current location in the itinerary data list.

Errands that block the thread need to be written in a special manner. This is necessary because after the event on which the process blocked occurs, the state of the errand (being on the kernel stack rather than an independent execution stack) is lost. Thus, in order to write potentially blocking threads an original state variable, referred hereinafter as errand state, is maintained in the itinerary data structure.

In the preferred embodiment of the invention, there is a per-thread errand state. This state is set to NEW_ERRAND whenever an errand is called for the first time by itinerary running service 118. In other words, the errand state for a thread is set to NEW_ERRAND, when a thread starts running in the itinerary mode. Besides, during an itinerary execution, when an errand returns with a return value of true and itinerary running service 118 is preparing to execute the next errand, the errand state is set to NEW_ERRAND.

If an errand is blocked, the errand function itself may set errand state to another value such as OLD_ERRAND. Itinerary running service 118 does not change the errand state and this has to be done inside the errand itself. This is useful for ascertaining the current state of the thread. The following exemplary pseudo-code illustrates the use of errand state variable.

```
wait_for_resource_errand_function ( )
{
    if(errand_state is NEW_ERRAND)
    {
        if (resource is available)
        {
            allocate resource to this thread;
            return true;
        }
        else (resource is not available)
        {
            enqueue thread in the wait queue
                of the resource;
            set errand_state to OLD_ERRAND;
            return false;
        }
    }
    else (errand_state is OLD_ERRAND)
    {
            return true;
    }
}
```

If the requested resource is not available at the time of execution of the above function, then it is allocated to the thread later by some other entity (like another thread or an interrupt service routine) when the resource becomes available. Such entity runs the following pseudo-code.

```
event that resource becomes available to thread
{
    allocate resource to a thread in wait queue;
    dequeue the allocated thread from wait queue;
    enqueue the thread in the ready queue of the scheduler;
    }
}
```

Itineraries written in accordance with the disclosed invention may also be shared by multiple threads within a multithreaded application. This is illustrated through the following exemplary thread configuration where a single producer thread is serving N consumer threads in round robin fashion. The following pseudo-code illustrates the standard thread programming methodology for achieving this purpose.

```
producer ( )
{
    for (;;)
    {
        for (i=0; i<N; i++)
        {
            semaphore_wait (consumed_sem [i]);
            produce_item (&array [i]);
            semaphore_post (produced_sem [i]);
        }
    }
}
consumer (t)
{
    for (;;)
    {
        semaphore_wait (produced_sem [t]);
        consume_item (&array [t]);
        semaphore_post (consumed_sem [t]);
    }
}
```

The above code can be itinerarized in the manner as explained earlier. The itinerary for the consumer thread may be programmed as follows.

begin_itinerary (itinerary [t], function_list [t], data_list [t]);
loophandle = errand_forever_begin (itinerary [t]);
errand_semaphore_wait (itinerary [t], sem1);
itk_add_errand (itinerary [t], consume_as_errand);
itk_put_data (itinerary [t], &array [t]);
errand_semaphore_post (itinerary [t], sem3);
errand_forever_end (itinerary [t], loophandle);
end_itnerary (itinerary [t]);

The itinerary built above would have the same function list for each of the threads. The parameters on the data list would be different. Thus, the same function list may be for each thread, saving local memory space.

Furthermore, if the errands have another way of accessing the variable t, then the data lists of the threads can be merged too. The data lists would then only store the array base addresses of produced_sem, array and consumed_sem. In addition, they would be indexed using the index t inside the errands themselves. Thus, all the threads would use the same function as well as data lists.

FIG. 5 is a flowchart that depicts the process steps occurring during execution of a preemptive errand in conjunction with the pseudo-code given above. A preemptive errand wait_for_resource_errand_function requests access to a resource. At step 502 the thread's errand state field is checked. If the value of errand state is not NEW_ERRAND, then it implies that the errand is not being executed for the first time and it has already been allocated the requested resource. The errand thus runs and calls itinerary running service with a return value of true when completed successfully at step 504. Henceforth, subsequent processing is continued by the itinerary running service. However, if the value of errand state field is NEW_ERRAND, then it implies that the errand is making a fresh request for the resource. At step 506 it is further checked whether the requested resource is available. If the resource is available, it is allocated to the thread at step 508. If the resource is not available, then the thread is queued in the resource's wait queue at step 510. At step 512, the value of the thread's errand state field is changed to OLD_ERRAND. Next at step 514 the errand returns a false return value and the itinerary is blocked.

In the meantime, the operating system runs other threads until a thread or event handler releases the requested resource at step 516. Next, at step 518 the first thread from the resource's wait queue is de-queued. It is allocated the resource and put in the scheduler ready queue. Eventually, at step 520, the operating system scheduler schedules the blocked itinerary back in. Since this thread is running in itinerary mode, it is executed through itinerary running service. The itinerary running service causes control to jump directly to the errand that returned false value earlier. Again, the thread's errand state field is checked. Since it is not NEW_ERRAND, the errand continues with its execution as explained earlier. Finally control is returned back to the itinerary that called the errand.

The following self-explanatory pseudo-code illustrates a manner of writing errands that are blocking in nature. The pseudo-code defines a function, which waits for a resource, if the resource not available. In case the resource is available, the function does a DMA (Direct Memory Access) transfer, blocking the thread while the DMA is in progress and then returns. This pseudo-code illustrates use of more than one errand blocking calls.

```
errand_wait_and_transfer (resource r, src, dest)
{
    switch (errand_state)
    {
        case NEW:
        if (r is available)
        {
            allocate r to this thread;
        }
        else
        {
            enqueue thread in r's wait queue;
            set errand_state =
                WAITING_FOR_RESOURCE;
            return False
        }
        case WAITING_FOR_RESOURCE:
        set errand_state =
                WAITING_FOR_DMA_TRANSFER;
        enqueue thread in DMA engine's wait queue;
        initiate DMA transfer from src to dest;
        return False;
        case WAITING_FOR_DMA_TRANSFER:
        return True;
    }
}
```

The various pseudo-codes described above illustrate some of the ways in which itinerarized threads maybe programmed using errands. It would be evident to one skilled in the art that these pseudo-codes have been provided only to illustrate the programming methodology of the disclosed invention, and in no way constrain the use of itinerarized threads.

The thread programming methodology of the disclosed invention has the inherent advantage of reducing thread switching overheads as well as memory usage, as explained earlier. This allows an application to be usefully broken into many more threads than otherwise possible. Lesser overheads lead to the possibility of finer-grained breakup of functionally parallel tasks, which leads to better processor utilization.

Whenever the thread needs to do more than one possibly blocking activities, putting those activities on a single itinerary reduces the switching overhead. Using errands for semaphore functions, processor allocation, computation and loops a thread may be programmed to spend its time entirely within an itinerary. Such a thread, after it starts the itinerary, runs forever inside the itinerary. This vastly saves on the thread switching overheads.

The method of the disclosed invention reduces the memory usage required for processing the threads. It is possible to store the few kernel stacks corresponding to each processor in fast local memory. In the standard stack execution model, each function call that the thread makes pushes old context and a new activation record on the stack. A complex program generally is written as a hierarchy of function calls. If a thread is itinerarized, it uses the local memory stacks during the entire period that it remains in the itinerary execution mode.

The disclosed invention is useful even if the system has a local cache instead of local memory. With itineraries the kernel stack will be used for processing all the time. Hence, it will remain in cache, whereas without itineraries various stacks will come in and go out of the cache, thus causing extensive cache congestion.

Certain applications may depend upon many interacting threads, each performing a simple repetitive task interleaved with synchronization operations. Such threads can be easily itinerarized as evident from the pseudo-codes described above.

Another advantage of programming threads using itineraries is that the itineraries enable the operating system to be application aware. In other words, the information about how the threads interact with each other can be easily obtained by looking at the itineraries. The operating system is running the itineraries, and the blocking of various tasks within the application is achieved through standard operating system mechanisms like semaphores. Hence a completely itinerarized stream application is logically equivalent to an operating system that knows what needs to be run, and in what priority order.

In an application, the threads are written to interact with each other using semaphores and other synchronization mechanisms. In the programming methodology of the disclosed invention, these semaphore primitives are written using errands, which can be seen directly in the errand function list. Thus, looking at the function list of a thread, it is easy to make out the flow of the thread.

Knowing how many threads wait on the completion of a particular errand could help the scheduler to schedule tasks in a prioritized manner to execute the worst bottlenecks first. In an embodiment of the invention, the scheduler schedules the threads in worst-bottleneck-first order. The worst bottleneck is the thread whose execution leads to the unblocking of a maximum number of blocked threads. For instance, in the exemplary itinerary pseudo-code described above, the thread does two waits, some computation and two posts. If the second wait has just been completed, and the computational errand is going to be run, one can trace the importance of the completion of this computational errand by seeing which threads will be unblocked directly or indirectly due to the completion of this errand. Looking ahead in the errand function list the various semaphore posts may be seen. Next, the semaphores that are being posted to can be figured out by looking at the data list. Next, one may figure out which threads are waiting on those semaphores. Thus, one may trace the logical execution of the threads to any level in the future.

Extracting such basic information from the machine code section of a standard thread would be much harder. This would require de-compiling the machine code to see what is happening. This would be followed by basic block analysis to get information about the code flow, and other techniques such as alias analysis to find what parameters the pertinent functions are being called with. In other words, it is a lot more difficult to extract information from standard threads as compared to just reading the information out of the itinerary function and data lists.

Another advantage of the programming methodology of the disclosed invention is with respect to debugging of an application program. Various thread interactions including semaphore operations and other interaction primitives are seen directly on the itinerary. If the threads are being run for debugging the parallel interactions, a special debugger may be written that can show the current state of each thread with reference to its itinerary. For instance, the debugger may show each thread as a list of errands possibly with special symbols or color combinations for standard errands like semaphore waits/posts etc. The debugger may further highlight the currently running errand, the currently blocked errand and errand that runs when the thread is scheduled in next. If all threads can be visualized in this manner, the interaction between the threads can be debugged in a more intuitive manner.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method for programming a multithreaded application so as to minimize thread switching overheads and memory usage during processing of the application, the method comprising:
a. writing a plurality of errands, the errands being functions performing specific tasks that collectively constitute the entire thread functionality; and
b. forming one or more itineraries corresponding to a thread, the itineraries controlling the execution of the errands in the desired manner.

2. The method as recited in claim 1 wherein an itinerary is shared by multiple threads within the multithreaded application.

3. The method as recited in claim 1 wherein forming the itinerary comprises:
a. storing information regarding the errands that need to be executed, the information being stored in the form of pointers to the actual errand functions, the pointers being stored in an errand function list;
b. storing the sequence in which the errands are to be executed, the sequence being the order in which the errand function pointers are stored within the errand function list; and
c. storing data required for execution of the errands within the itinerary, the data being stored in an errand data list.

4. The method as recited in claim 3 wherein forming the itinerary further comprises defining an errand state field, the errand state field capable of being modified by preemptive errands, the preemptive errands being functions that may cause the thread to temporarily stall further execution, the value assigned to the errand state field at any point of thread execution being indicative of the state of the thread.

5. A method for executing a multithreaded application, the multithreaded application having been programmed using itinerarized threads, the itinerarized threads comprising standard thread constructs as well as itineraries, the itineraries being lists of errands, the errands being functions performing specific tasks, the method comprising:
a. compiling the application code;
b. scheduling the plurality of threads for execution;
c. executing threads running standard thread constructs in normal mode, the normal mode of execution being thread execution in accordance with standard thread execution methodology, the normal-mode execution of a thread being carried out using an execution stack associated with the thread;
d. executing itineraries in itinerary mode, the itinerary mode being a special thread execution scheme for executing the complete itinerary, the itinerary mode execution of a thread being carried out using a kernel stack;
e. exiting the itinerary mode of execution when the complete itinerary corresponding to a thread has been executed, the thread being subsequently executed in normal mode.

6. The method as recited in claim 5 wherein itinerary execution is carried out after preempting the thread running in normal mode in response to a request for running the itinerary on behalf of the thread.

7. The method as recited in claim 5 wherein scheduling the plurality of threads comprises:
a. sequentially queuing the plurality of threads for resource allocation based on predefined criteria, the queuing being done for allocation of each resource to the threads; and
b. allocating a resource to the threads in accordance with the queue maintained for the resource.

8. The method as recited in claim 7 wherein executing threads in the normal mode comprises:
a. loading the thread context, the thread context being information required for execution of the thread;
b. executing thread specific logic; and
c. preempting the thread in response to a request for the thread preemption, the thread preemption being done after storing the thread context in the execution stack associated with the thread and storing a pointer to the execution stack in the thread structure.

9. The method as recited in claim 5 wherein executing threads in the itinerary mode comprises:
a. setting up the itinerary, the setting up of the itinerary comprising:
i. setting up the kernel stack, the kernel stack being set up in such a manner that it becomes the execution stack for the itinerary;
ii. setting up an errand state variable, the errand state variable being subsequently used for ascertaining the state of the thread running the errand;
iii. setting up an errand function list, the errand function list storing pointers to the actual errand functions;
iv. setting up an errand data list, the errand data list storing data required for execution of the errands; and
v. storing pointers to the errand function list and errand data list, the pointers being used subsequently for accessing the lists; and
b. executing the errands corresponding to the itinerary sequentially, the sequence of the errands being specified through the errand function list, the errands being executed using data stored in the errand data list.

10. The method as recited in claim 9 wherein the sequence of executing the errands is modified by conditional errands, conditional errands being errands that change the sequence of errand execution based upon certain predefined conditions.

11. The method as recited in claim 9 wherein executing errands sequentially comprises: while the complete itinerary is not executed, iteratively performing the following steps:
a. loading an errand for execution, the errand being loaded in accordance with the specified sequence of errands in the errand function list;
b. running the errand and receiving the return value returned by the errand, a true return value indicating that the errand was executed successfully, a false return value indicating that the errand blocked and did not complete successfully;
c. executing the next errand in the errand function list in response to a true return value returned by the errand being executed;
d. blocking the itinerary in response to a false return value returned by the errand being executed, the blocking being done in the itinerary mode; and
e. resuming itinerary execution when the blocked itinerary is scheduled back, the itinerary execution being resumed from the errand that had caused the itinerary to block.

12. The method as recited in claim 11 wherein running an errand comprises:
a. checking the value of the errand state field of the itinerary, the errand state field being checked for ascertaining whether the errand is being executed for the first time or it is a previously blocked errand, the errand returning a true value if it is a previously blocked errand;
b. executing the complete errand in case the errand is being executed for the first time;
c. returning a true return value if the complete errand is executed successfully; and
d. modifying the errand state field and returning a false return value if the errand is blocked, the errand state field being modified to indicate that the errand is being blocked.

13. A multithreaded application processing system executing a multithreaded application program, the program comprising a plurality of standard threads and itinerarized threads, the standard threads having been written using standard thread methodology, the itinerarized threads comprising standard thread constructs and itineraries, the itineraries being lists of errands, the errands being functions performing specific tasks, the system comprising:
a. a compiler compiling the application program;
b. a memory storing information related to the threads, the memory comprising:
i. a plurality of thread stacks, each of the thread stacks being associated with a thread, the stack being stored with context information pertaining to the thread, the context information being the information set required for processing of the thread; and
ii. a kernel stack, the kernel stack being used by the itinerarized threads while the itineraries are being processed;
c. a processor processing the plurality of threads, the processor accessing the memory for information pertaining to the plurality of threads; and
d. an operating system scheduling and managing execution of the plurality of threads, the operating system executing the standard threads and standard thread constructs of itinerarized threads in accordance with standard thread execution methodology, the operating system executing itineraries in itinerary mode, the itinerary mode being a thread execution scheme for executing the complete itinerary.

14. The system as recited in claim 13 wherein the multithreaded processing system utilizes multiple processors, each of the multiple processors having a separate kernel stack associated with it in the memory.

15. The system as recited in claim 13 wherein the operating system comprises:
a. a scheduler scheduling various standard and itinerarized threads for execution;
b. a standard thread running service executing various standard threads and standard thread constructs of itinerarized threads; and
c. an itinerary running service executing the itineraries corresponding to the itinerarized threads in itinerary mode.

16. The system as recited in claim 15 wherein the scheduler comprises:
a. a ready queue for holding the plurality of threads ready for execution, the plurality of threads being standard as well as itinerarized threads ready for execution;
b. means for prioritizing the plurality of threads on the basis of pre-defined criteria; and
c. means for scheduling the plurality of threads in order of priority as defined by the pre-defined criteria.

17. The system as recited in claim 16 wherein the scheduler maintains separate ready queues for holding the standard and itinerarized threads.

18. The system as recited in claim 15 wherein the standard thread running service comprises:
a. a preemption service enabling thread preemption;
b. standard preemptive services, the preemptive services being specific activities that might preempt the thread, the standard preemptive services using the preemption service for execution; and
c. standard non-preemptive services, the non-preemptive services being specific activities that do not need a thread to preempt.

19. The system as recited in claim 15 wherein the itinerary running service comprises:
a. a preemption service enabling thread preemption;
b. standard preemptive services, the preemptive services being specific activities that can preempt the thread, the standard preemptive services using the preemption service for execution;
c. standard non-preemptive services, the non-preemptive services being specific activities that do not need a thread to preempt; and
d. an itinerary building service, the itinerary building service facilitating execution of itinerary specific program constructs.

20. An itinerary running service for executing an itinerarized thread in itinerary mode, the itinerarized thread comprising standard thread constructs and itineraries, the itineraries being lists of errands, the errands being small tasks needed to be performed during thread execution, the itinerary mode being a special thread execution scheme for executing the complete itinerary, the itinerary running service receiving the itinerary from an operating system scheduler, the itinerary running service comprising:
a. means for providing various preemptive and non-preemptive services to the itinerary, the preemptive services being specific activities that may preempt the thread to preempt, the non-preemptive services being specific activities that do not need the thread to preempt;
b. an itinerary building service providing pre-programmed standard errands and enabling specification of application specific errands, the standard errands being various preemptive and non-preemptive services provided by the system, the application specific errands being special program constructs built into the itinerary;
c. means for executing the errands in the itinerary sequentially; and
d. means for blocking the itinerary when one of the errands blocks.

21. The itinerary service as recited in claim 20 further comprising means for resuming execution of a previously blocked itinerary from the errand that blocked the itinerary, when the itinerary is scheduled back on the itinerary running service by the operating system scheduler.

22. A computer program product for executing a multithreaded application, the application having been programmed using itinerarized threads, the itinerarized threads comprising standard thread constructs as well as itineraries, the itineraries being lists of errands, the errands being functions performing specific tasks, the computer program product comprising:
a computer readable medium comprising:
a. program instruction means for compiling the application code;
b. program instruction means for scheduling the plurality of threads for execution; and
c. program instruction means for executing the plurality of threads in a manner that minimizes thread switching overheads and memory usage during the execution, the standard threads being executed using thread stacks associated with the threads as execution stacks, the itineraries being executed using kernel stack as their execution stack.

23. The computer program product as recited in claim 22 wherein the computer readable medium comprising program instruction means for executing the plurality of threads further comprises:
a. program instruction means for executing threads running standard thread constructs in normal mode, the normal mode of execution being thread execution in accordance with standard thread execution methodology;
b. program instruction means for preempting a thread running in normal mode in response to a request for running an itinerary on behalf of the thread, the preempted thread subsequently being run in itinerary mode, the itinerary mode being a special thread execution scheme for executing the complete itinerary; and
c. program instruction means for exiting the itinerary mode of execution when the complete itinerary corresponding to a thread has been executed, the thread being subsequently executed in normal mode.
